(19) United States
(12) Patent Application Publication
(10) Pub. No.: US 2026/0237116 A1
(43) Pub. Date: Aug. 13, 2026

(54) GENERATING LAYERED DIGITAL DESIGNS FROM SKETCHES USING DEEP LEARNING

(71) Applicant: Adobe Inc., San Jose, CA (US)

(72) Inventors: Kaushal Kishore, New Delhi (IN); Nitesh Dodeja, Delhi (IN); Garv Tandon, Greater Noida (IN); Avneet Kaur, New Delhi (IN); Hemant Kasat, Noida (IN); Vineet Batra, Pitam Pura (IN)

(21) Appl. No.: 19/051,596

(22) Filed: Feb. 12, 2025

(51) Int. Cl. G06T 11/60; G06T 11/20; G06T 15/02

(52) U.S. Cl. CPC G06T 11/60; G06T 11/23; G06T 15/02

(57) ABSTRACT

The present disclosure relates to systems, non-transitory computer-readable media, and methods for generating layered digital design documents from sketches utilizing deep learning. In particular, the disclosed systems determine at least one of a canvas size or an aspect ratio of a sketch image. Additionally, the disclosed systems generate, based on the at least one of the canvas size or the aspect ratio, a compositional reference of the sketch image utilizing a binarization model by normalizing lighting of the sketch image, enhancing contrast of the sketch image, and converting the sketch image to a binary format. Further, the disclosed systems generate, utilizing one or more machine learning models, a digitized digital design of the sketch image based on the compositional reference. Moreover, the disclosed systems generating a layered digital design document comprising a background layer based on the digitized digital design and editable text elements based on the compositional reference.

### BACKGROUND

Recent years have seen significant advancements in hardware and software platforms for creating and modifying digital design documents. For example, many platforms offer software applications that provide tools to modify objects within digital design documents. For instance, many platforms provide templates to select from to use as a digital design document. Despite advancements in creating and modifying digital design documents, conventional platforms suffer from a variety of issues in relation to efficiency, accuracy, and operational flexibility of creating and modifying digital design documents.

### SUMMARY

Embodiments of the present disclosure provide benefits and/or solve one or more of the foregoing or other problems in the art with systems, non-transitory computer-readable media, and methods for generating a layered digital design document from a sketch utilizing deep learning. In particular, in one or more embodiments, the disclosed systems convert rough sketches (e.g., hand drawings) into edible layered digital designs using one or more machine learning models. Thus, one or more embodiments generate cohesive, thematically aligned backgrounds, text, and graphic elements. The resulting documents contain a background canvas, editable text fields with cohesive fonts and styles, and graphic elements that reflect the objects, style, and size of the original sketch. The discloses systems streamline the design process while also enabling users without design expertise to easily create visually appealing layered digital design documents.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a sketch to layered-digital-design system operates in accordance with one or more embodiments.

FIG. 2 illustrates an overview diagram of the sketch to layered-digital-design system generating a layered digital design document from a sketch image in accordance with one or more embodiments.

FIG. 3 illustrates a diagram of the sketch to layered-digital-design system generating a compositional reference from a sketch image in accordance with one or more embodiments.

FIG. 4 illustrates a diagram of the sketch to layered-digital-design system generating a digitized digital design of a sketch image in accordance with one or more embodiments.

FIG. 5 illustrates a diagram of the sketch to layered-digital-design system generating a background layer of a digital design document from a digitized digital design in accordance with one or more embodiments.

FIG. 6 illustrates a diagram of the sketch to layered-digital-design system generating a layered digital design document of the sketch image in accordance with one or more embodiments.

FIG. 7 illustrates an example schematic diagram of the sketch to layered-digital-design system in accordance with one or more embodiments.

FIG. 8A illustrates a flowchart of an example series of acts for generating a layered digital design document from a sketch image in accordance with one or more embodiments.

FIG. 8B illustrates a flowchart of an example series of acts for generating a digitized digital design utilizing a deep learning model based on image embeddings and text embeddings generated from a compositional reference of a sketch image in accordance with one or more embodiments.

FIG. 8C illustrates a flowchart of an example series of acts for generating a layered digital design document including a background layer and editable text elements in accordance with one or more embodiments.

FIG. 9 illustrates an example of a guided diffusion model according to aspects of the present disclosure;

FIG. 10 shows an example of a U-Net according to aspects of the present disclosure;

FIG. 11 shows an example of a method for conditional media generation according to aspects of the present disclosure;

FIG. 12 shows a diffusion process according to aspects of the present disclosure;

FIG. 13 shows a flow diagram depicting an algorithm as a step-by-step procedure for training a machine-learning model according to aspects of the present disclosure;

FIG. 14 shows an example of a method for training a diffusion model according to aspects of the present disclosure;

FIG. 15 shows an example of a computing device according to aspects of the present disclosure; and

FIG. 16 shows an example of a sketch to layered-digital-design system apparatus according to aspects of the present disclosure.

### DETAILED DESCRIPTION

This disclosure describes one or more embodiments of a sketch to layered-digital-design system that generates a layered digital design document from a sketch utilizing a custom binarization model and machine learning models. In particular, the sketch to layered-digital-design system generates a compositional reference of a sketch image utilizing a custom binarization model by identifying and reconstructing text from the sketch image. Additionally, in one or more embodiments, the sketch to layered-digital-design system generates a digitized digital design of the sketch image based on the compositional reference utilizing a diffusion model and optionally one or more other machine learning models. Further, in one or more implementations, the sketch to layered-digital-design system generates a background layer based on the digitized digital design utilizing a segmentation model and an inpainting model. Moreover, in one or more embodiments, the sketch to layered-digital-design system generates a layered digital design document using the background layer and reconstructed editable text elements.

As mentioned above, in one or more implementations, the sketch to layered-digital-design system generates a compositional reference of a sketch image utilizing a custom binarization model by identifying and reconstructing text from the sketch image. For example, in one or more embodiments, the compositional reference includes a digital image with image components and/or editable text elements based on the images and text of the sketch image. Specifically, in one or more implementations, the sketch to layered-digital-design system determines a canvas size and/or aspect ratio of the sketch image. Furthermore, in one or more embodiments, the sketch to layered-digital-design system utilizes the binarization model to perform various operations such as smoothing noise, normalizing lighting, enhancing contrast, converting the sketch image to a binary image, etc. In one or more implementations, the sketch to layered-digital-design system generates a clean sketch image via the foregoing actions.

Additionally, in one or more embodiments, the sketch to layered-digital-design system performs text identification and reconstruction on the text of the clean sketch image to generate the compositional reference with editable text elements.

As noted above, in one or more implementations, the sketch to layered-digital-design system generates a digitized digital design of the sketch image based on the compositional reference utilizing a diffusion model and other machine learning models. In one or more embodiments, the digitized digital design includes a digital image (e.g., a raster image) with a generated design based on and including the images and editable text elements of the compositional reference. In particular, in one or more implementations, the sketch to layered-digital-design system utilizes a vision-language model to generate text-to-image prompts from the compositional reference. Further, in one or more embodiments, the sketch to layered-digital-design system utilizes a text encoder to generate text embeddings based on the text-to-image prompts. Moreover, in one or more implementations, the sketch to layered-digital-design system utilizes an image encoder to generate image embeddings from the compositional reference. Furthermore, in one or more embodiments, the sketch to layered-digital-design system generates the digitized digital design (e.g., in the format of a raster image) of the sketch image by conditioning a diffusion model on the text embeddings and the image embeddings.

As mentioned previously, in one or more implementations, the sketch to layered-digital-design system generates a background layer based on the digitized digital design utilizing a segmentation model and an inpainting model. Specifically, in one or more embodiments, the sketch to layered-digital-design system utilizes a segmentation model to extract text regions from the digitized digital design. Additionally, in one or more implementations, the sketch to layered-digital-design system generates a completed background layer from the digitized digital design utilizing an inpainting model to inpaint regions of the digitized digital design corresponding to the extracted text regions.

As noted previously, in one or more embodiments, the sketch to layered-digital-design system generates a layered digital design document of the sketch image using the background layer and reconstructed editable text elements. In particular, in one or more implementations, the sketch to layered-digital-design system performs layered vectorization on visual elements of the background layer. For instance, the sketch to layered-digital-design system segments visual elements of the background layer and fills the segmented visual elements. Further, in one or more embodiments, the sketch to layered-digital-design system overlays editable text elements reconstructed from the clean sketch image on the background layer.

Although conventional systems are able to generate layered design documents, such systems have a number of problems in relation to efficiency and accuracy. For instance, conventional systems inefficiently generate layered design documents. Specifically, conventional systems often require many user interactions and interfaces to generate a layered design document. For example, conventional systems often require many user interactions such as typing out text, searching for the correct fonts, creating each graphic of the design manually, etc.

In addition to their inefficiencies, conventional systems inaccurately generate layered design documents. More particularly, conventional systems often generate design documents with mismatched themes, colors, and styles. Moreover, conventional systems often fail to account for non-uniform lighting conditions at capture time of elements for the digital design, which results in a variety of artifacts such as shadows, glare, and uneven illumination resulting in reduced quality of the document image and reduced accuracy in the final design. Furthermore, conventional systems typically use a fixed set of fonts that does not change from design to design. These strategies often result in mismatched themes, colors, and styles due to the fragmented process where components are generated separately and then assembled.

As suggested by the foregoing, one or more embodiments of the sketch to layered-digital-design system provide a variety of improvements relative to conventional systems. For example, by automatically generating the digital design document from a sketch image, the sketch to layered-digital-design system improves efficiency relative to conventional systems. In particular, in one or more implementations, the sketch to layered-digital-design system automatically generates the digital design document in response to receiving a single interaction (e.g., a single button click). Thus, the need for multiple inputs such as typing out text, searching for the correct fonts, creating each graphic for the design, and arranging the graphics, text, background, etc. is avoided. Additionally, in one or more embodiments, the sketch to layered-digital-design system provides improved graphical user interfaces for generating a layered digital design document. In contrast to conventional systems that require users to access and use a number of different graphical user interface tools, menus, and interactions to manually generate the layered digital design document from a sketch image, the sketch to layered-digital-design system provides a graphical user interface and system that provides the layered digital design document in response to minimal user interactions.

Additionally, by generating cohesive, thematically aligned backgrounds, text, and graphic elements, the sketch to layered-digital-design system improves accuracy relative to conventional systems. Specifically, in one or more embodiments, the sketch to layered-digital-design system generates cohesive, thematically aligned backgrounds by generating a compositional reference from the sketch image and utilizing the compositional reference with deep learning to generate a digitized digital design. Further, in one or more implementations, the sketch to layered-digital-design system generates cohesive, thematically aligned backgrounds by generating a complete background layer (e.g., via inpainting) from the digitized digital design and overlaying text extracted from the sketch image on the complete background. Moreover, in one or more embodiments, the sketch to layered-digital-design system uses vectorization with inpainting for enhanced editability, cleaner backgrounds, and a refined process that ensures a more cohesive design with matched themes, colors, and styles. Further, in one or more implementations, the sketch to layered-digital-design system uses a custom binarization pipeline to reduce artifacts such as shadows, glare, and uneven illumination introduced into a sketch image at capture time of the rough sketches. Additionally, in one or more embodiments, rather than using a fixed set of fonts, the sketch to layered-digital-design system infers fonts using a font match model.

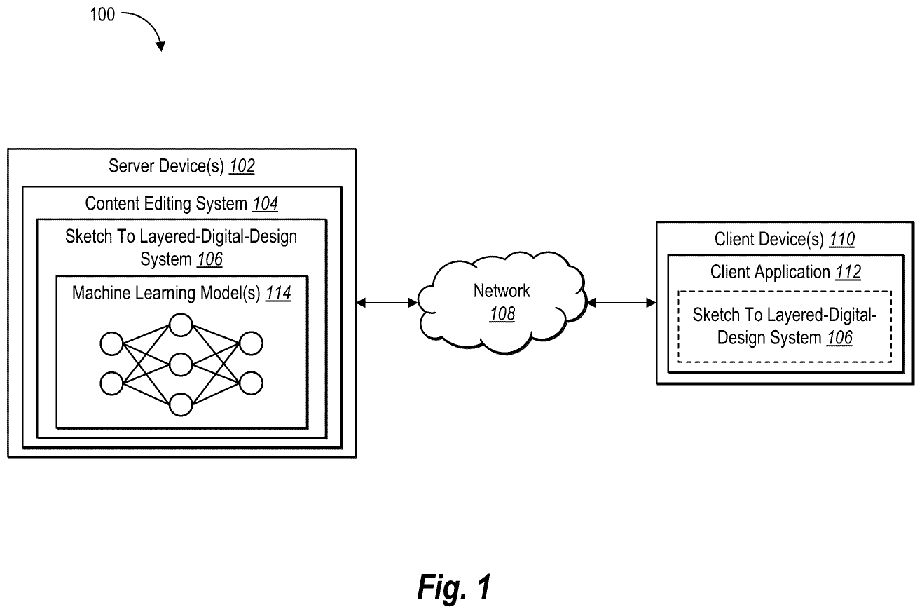

Additional detail regarding the sketch to layered-digital-design system 106 will now be provided with reference to the figures. For example, FIG. 1 illustrates a schematic diagram of a system environment 100 in which a sketch to layered-digital-design system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the sketch to layered-digital-design system 106 via the network 108). Similarly, although FIG. 1 illustrates a particular arrangement of the server device(s) 102, the network 108, and the client device(s) 110, various additional arrangements are possible.

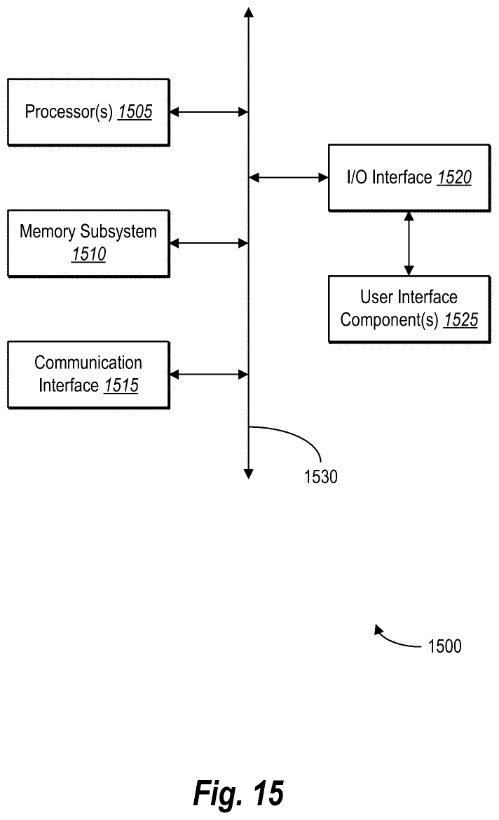

The server device(s) 102, the network 108, and the client device(s) 110 are communicatively coupled with each other either directly or indirectly (e.g., through the network 108 discussed in greater detail below in relation to FIG. 15). Moreover, the server device(s) 102 and the client device(s) 110 include one or more of a variety of computing devices (including one or more computing devices as discussed in greater detail with relation to FIG. 15).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In one or more implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device(s) 110) views, generates, stores, and/or edits layered digital design documents including artificial intelligence content. For example, in some instances, a client device sends a sketch image to the content editing system 104 hosted on the server device(s) 102 via the network 108. The content editing system 104 provides options usable by the client device to edit the sketch image to generate a layered digital design document, store the layered digital design document, and subsequently search for, access, and view the layered digital design document. To illustrate, the content editing system 104 provides one or more options that are usable by the client device to access one or more machine learning model(s) 114 and/or generate content therefrom.

In one or more embodiments, the sketch to layered-digital-design system 106 generates a clean sketch image from a sketch image and generates a compositional reference including editable text elements from the clean sketch image. Furthermore, as will be explained below, the sketch to layered-digital-design system 106 generates a digitized digital design from the compositional reference utilizing the machine learning model(s) 114. Additionally, in one or more implementations, the sketch to layered-digital-design system 106 generates a background layer based on the digitized digital design by extracting text regions from the digitized digital design and inpainting the regions corresponding to the extracted text regions. Further, the sketch to layered-digital-design system 106 generates a layered digital design document based on the background layer and editable text elements.

As illustrated in FIG. 1, the sketch to layered-digital-design system 106 includes machine learning model(s) 114. Indeed, in these or other embodiments, the sketch to layered-digital-design system 106 accesses the machine learning model(s) 114 or implements the machine learning model(s) 114 to generate and/or implement generated outputs such as text or image embeddings, text-to-image prompts, and/or digitized digital designs. In some cases, the machine learning model(s) 114 are external to the sketch to layered-digital-design system 106, but the sketch to layered-digital-design system 106 nevertheless accesses and utilizes the machine learning model(s) 114 via one or more plugins, APIs, or other network-based access protocols.

A machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

In one or more embodiments, the client device(s) 110 includes a computing device that accesses, edits, segments, modifies, stores, and/or provides, for display, digital content such as digital design documents with artificial intelligence generated content. For example, in one or more embodiments, the client device(s) 110 includes a smartphone, a tablet, a desktop computer, a laptop computer, a head-mounted-display device, or another electronic device, including those explained below with reference to FIG. 15. In some instances, the client device(s) 110 includes one or more applications (e.g., a client application 112) that access, edit, segment, modify, store, and/or provide, for display, digital content such as digital design documents with artificial intelligence generated content. For example, in one or more embodiments, the client application 112 includes a software application installed on the client device(s) 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicates via the network using one or more communication platforms and technologies suitable for transporting data and/or communication signals, including any known communication technologies, devices, media, and protocols supportive of data communications, examples of which are described with reference to FIG. 15.

To provide an example implementation, in one or more embodiments, the sketch to layered-digital-design system 106 on the server device(s) 102 supports the sketch to layered-digital-design system 106 on the client device(s) 110. For instance, in some cases, the sketch to layered-digital-design system 106 on the server device(s) 102 generates or learns parameters for the machine learning model(s) 114. The sketch to layered-digital-design system 106, via the server device(s) 102, provides the machine learning model(s) 114 to the client device(s) 110. In other words, the client device(s) 110 obtains (e.g., downloads) the machine learning model(s) 114 from the server device(s) 102. Once downloaded, the sketch to layered-digital-design system 106 on the client device(s) 110 uses the machine learning model(s) 114 to generate and implement outputs such as text embeddings, text-to-image prompts, image embeddings, and/or digitized digital designs independent of the server device(s) 102. In one or more alternative implementations, the sketch to layered-digital-design system 106 generates or learns parameters for the machine learning model(s) 114 on the client device(s) 110.

In alternative implementations, the sketch to layered-digital-design system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a training data, sketch images, and/or digital design documents for use as input and/or for incorporation with the output of the machine learning model(s) 114. In response, the sketch to layered-digital-design system 106 on the server device(s) 102 generates text embeddings, text-to-image prompts, image embeddings, and/or digitized digital designs using the machine learning model(s) 114. The server device(s) 102 then provides the text embeddings, text-to-image prompts, image embeddings, and/or digitized digital designs to the client device(s) 110 for display and/or further processing.

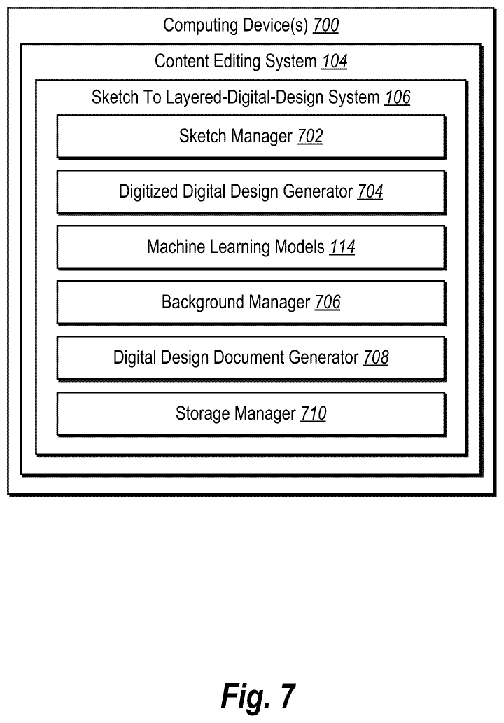

Although FIG. 1 illustrates the sketch to layered-digital-design system 106 implemented with regard to the server device(s) 102, different components of the sketch to layered-digital-design system 106 are able to be implemented by a variety of devices within the system environment 100. For example, in some instances, a different computing device (e.g., the client device(s) 110) or a separate server from the server device(s) 102 implements one or more (or all) components of the sketch to layered-digital-design system 106. Indeed, as shown in FIG. 1, the client device(s) 110 includes the sketch to layered-digital-design system 106. Example components of the sketch to layered-digital-design system 106 will be described below with regard to FIG. 7.

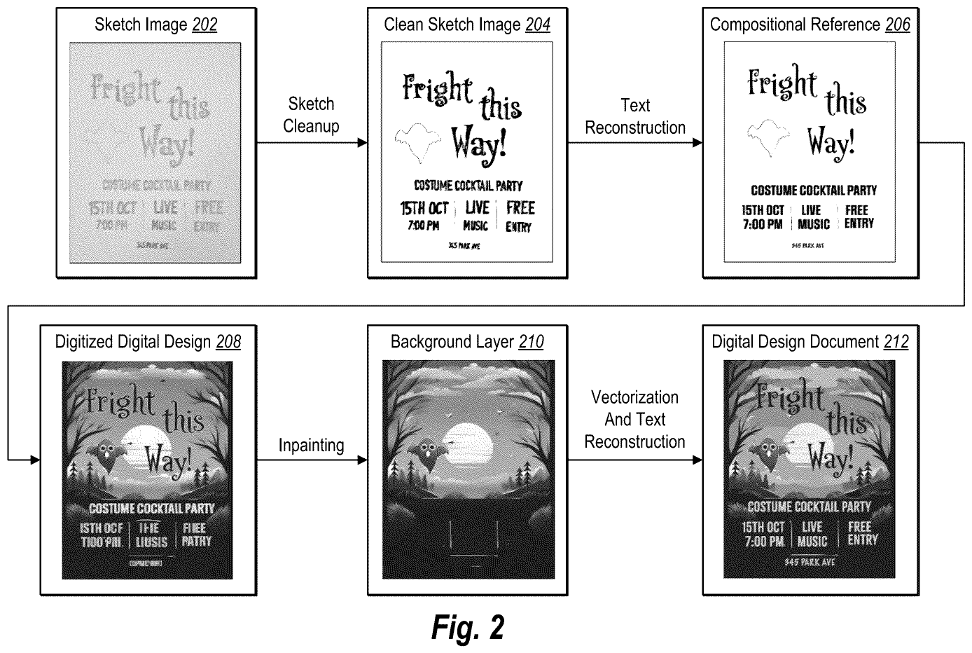

As previously mentioned, in one or more embodiments, the sketch to layered-digital-design system 106 generates a layered digital design document from a sketch image utilizing a custom binarization model and machine learning models. FIG. 2 illustrates an overview diagram of the sketch to layered-digital-design system 106 generating a layered digital design document of a sketch image in accordance with one or more embodiments.

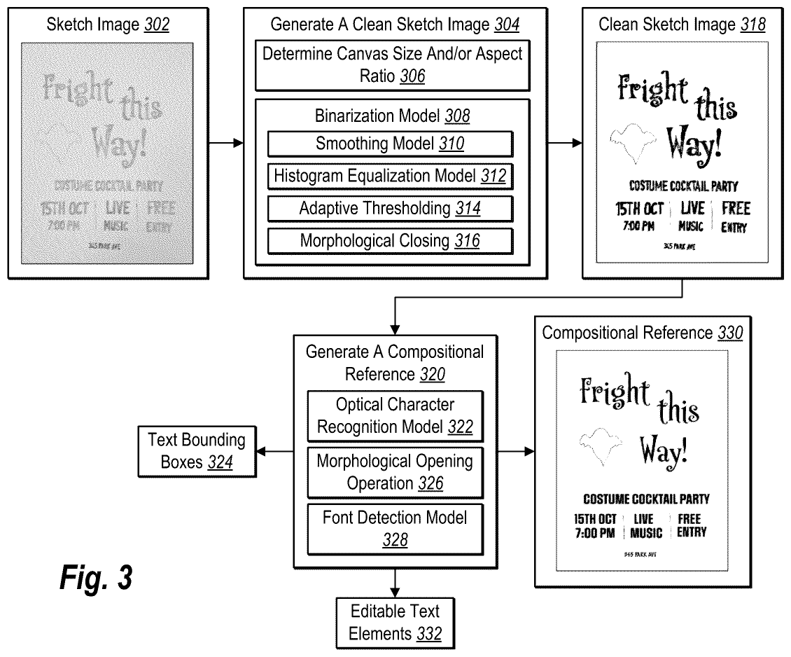

As illustrated in FIG. 2, in one or more implementations, the sketch to layered-digital-design system 106 performs a sketch cleanup on a sketch image 202 to generate a clean sketch image 204. In particular, in one or more embodiments, the sketch to layered-digital-design system 106 determines a canvas size and aspect ratio of the sketch image as part of the sketch cleanup. Moreover, in one or more implementations, the sketch to layered-digital-design system 106 also utilizes a custom binarization model to generate the clean sketch image 204. In one or more embodiments, the binarization model includes utilizing a smoothing model and a histogram equalization model as well performing adaptive thresholding and morphological closing. Additional detail regarding generating the clean sketch image 204 from the sketch image 202 is provided with respect to FIG. 3.

As further illustrated in FIG. 2, in one or more implementations, the sketch to layered-digital-design system 106 generates a compositional reference 206 from the clean sketch image 204. Specifically, in one or more embodiments, the sketch to layered-digital-design system 106 performs text reconstruction to generate the compositional reference 206. For example, in one or more implementations, the sketch to layered-digital-design system 106 extracts text strings from the clean sketch image 204 using an optical character recognition model. Furthermore, in one or more embodiments, the sketch to layered-digital-design system 106 determines a font of the text strings based on the clean sketch image 204 utilizing a font detection model. Additional detail regarding generating the compositional reference 206 from the clean sketch image 204 is provided with respect to FIG. 3.

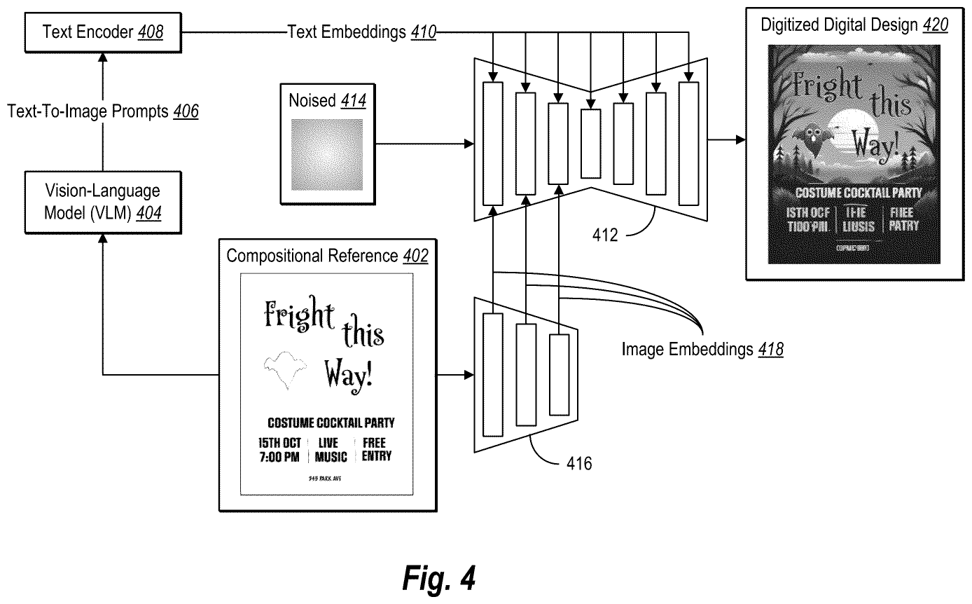

As additionally shown in FIG. 2, in one or more implementations, the sketch to layered-digital-design system 106 generates a digitized digital design 208 from the compositional reference 206. In particular, the sketch to layered-digital-design system 106 utilizes a vision-language model to generate text-to-image prompts from the compositional reference 206. Additionally, in one or more embodiments, the sketch to layered-digital-design system 106 utilizes a text encoder to generate text embeddings based on the text-to-image prompts. Further, in one or more implementations, the sketch to layered-digital-design system 106 utilizes an image encoder to generate image embeddings from the compositional reference 206. Moreover, in one or more embodiments, the sketch to layered-digital-design system generates the digitized digital design 208 of the sketch image by conditioning a diffusion model on the text embeddings and the image embeddings. Additional detail regarding generating the digitized digital design 208 from the compositional reference 206 is provided with respect to FIG. 4.

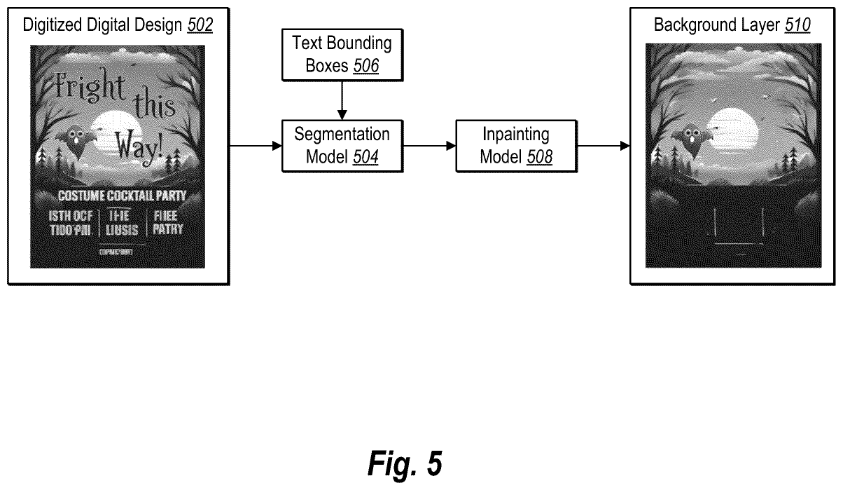

As further illustrated in FIG. 2, in one or more implementations, the sketch to layered-digital-design system 106 generates a background layer 210 from the digitized digital design 208. Specifically, in one or more embodiments, the sketch to layered-digital-design system 106 generates the background layer 210 via inpainting. For instance, in one or more implementations, the sketch to layered-digital-design system 106 utilizes a segmentation model to extract text regions from the digitized digital design 208. Furthermore, in one or more embodiments, the sketch to layered-digital-design system 106 generates a completed background layer from the digitized digital design 208 utilizing an inpainting model to inpaint regions of the digitized digital design 208 corresponding to the extracted text regions. Additional detail regarding generating the background layer 210 is provided with respect to FIG. 5.

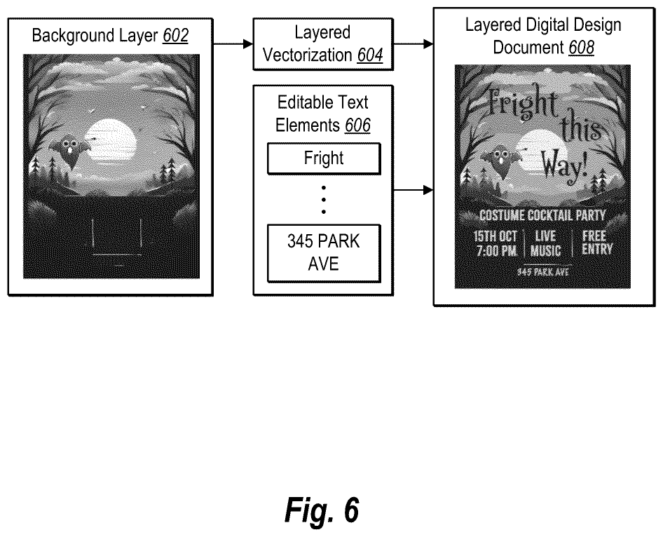

As also depicted in FIG. 2, in one or more implementations, the sketch to layered-digital-design system 106 generates a layered digital design document 212 from the background layer 210. In particular, the sketch to layered-digital-design system 106 performs layered vectorization on visual elements (e.g., editable text elements) of the background layer and text reconstruction. For example, in one or more embodiments, the sketch to layered-digital-design system 106 segments visual elements of the background layer and fills the segmented visual elements. Additionally, in one or more implementations, the sketch to layered-digital-design system overlays editable text elements reconstructed from the clean sketch image 204 on the background layer. Further, in one or more embodiments, the sketch to layered-digital-design system 106 performs text reconstruction on the editable text elements, for example by reconstructing the text color, etc. Additional detail regarding generating the layered digital design document 212 from the background layer 210 is provided with respect to FIG. 6.

As previously noted, in one or more implementations, the sketch to layered-digital-design system 106 generates a compositional reference of a sketch image. Indeed, in one or more embodiments, the sketch to layered-digital-design system 106 generates a clean sketch image from a sketch image and generates the compositional reference from the clean sketch image. FIG. 3 illustrates a diagram of the sketch to layered-digital-design system 106 generating a compositional reference from a sketch image in accordance with one or more embodiments.

As shown in FIG. 3, in one or more implementations, the sketch to layered-digital-design system 106 performs an act 304 of generating a clean sketch image 318 (e.g., clean sketch image 204) from a sketch image 302 (e.g., sketch image 202). Specifically, in one or more embodiments, the sketch to layered-digital-design system 106 receives from a client device a sketch image 302 from a rough sketch. In one or more implementations, the sketch image 302 includes a digital image (e.g., in any format including .jpg, .png, .tiff, etc.) of a rough sketch. In these or other embodiments, a rough sketch includes a hand-drawn design sketch or other non-digital design sketch.

As mentioned above, in one or more embodiments, the sketch to layered-digital-design system 106 performs the act 304 of generating the clean sketch image 318 from the sketch image 302. In particular, in one or more implementations, performing the act 304 includes performing an act 306 of determining a canvas size and/or an aspect ratio of the sketch image 302. For instance, in one or more embodiments, the sketch to layered-digital-design system 106 determines the edges of the rough sketch in the sketch image 302 or the sketch image 302 itself. In these or other embodiments, the sketch to layered-digital-design system 106 determines the four corners and/or the top, bottom, and side edges. Based on the determined edges of the rough sketch (or sketch image 302), the sketch to layered-digital-design system 106 determines the canvas size of the sketch image 302 and applies the canvas size to the clean sketch image 318 when generating the clean sketch image 318.

As noted above, in one or more implementations, the sketch to layered-digital-design system 106 determines the aspect ratio of the sketch image 302 as part of performing the act 306. Specifically, in one or more embodiments, the sketch to layered-digital-design system 106 corrects the perspective of the sketch image 302 to obtain a flat and/or aligned image of the sketch image 302. Based on the flat image the sketch to layered-digital-design system 106 determines the aspect ratio of the sketch image 302.

As further illustrated in FIG. 3, in one or more implementations, the sketch to layered-digital-design system 106 utilizes a custom binarization model 308 to generate the clean sketch image 318. In one or more embodiments, a binarization model includes utilizing one or more models and/or performing one or more operations to remove and/or reduce artifacts of a digital image such as a sketch image. In particular, in one or more implementations, a binarization model removes and/or reduces artifacts such as shadows, glare, uneven illumination, etc. introduced in a digital image at image capture time. Additionally, in one or more embodiments, a binarization model includes a model and/or operation that converts a digital image to a binary format. For example, in one or more implementations, a binarization model includes applying a smoothing technique, an equalization technique, an adaptive thresholding technique, and/or morphological closing.

Specifically, in one or more embodiments, the sketch to layered-digital-design system 106 utilizes the binarization model 308 as part of the act 306 of generating the clean sketch image after performing the act 306 of determining the canvas size and/or aspect ratio of the sketch image 302. In these or other embodiments, the sketch to layered-digital-design system 106 generates the clean sketch image 318 based on the canvas size and/or the aspect ratio of the sketch image 302 by utilizing the binarization model 308 on the sketch image 302 with the correct canvas size and/or aspect ratio.

As additionally shown in FIG. 3, in one or more implementations, the sketch to layered-digital-design system 106 utilizes a smoothing model 310 as part of the binarization model 308. In one or more embodiments, a smoothing model includes utilizing a smoothing technique to reduce image noise, soften edges, etc. For instance, in one or more implementations, a smoothing model includes one or more smoothing techniques such as gaussian blur, applying a filter such as a mean, median, or bilateral filter, etc. In particular, in one or more embodiments, the sketch to layered-digital-design system 106 utilizes the smoothing model 310 to smooth noise of the sketch image 302. For example, in one or more implementations, the sketch to layered-digital-design system 106 utilizes gaussian blur with a 5×5 kernel to smooth the noise of the sketch image 302.

As further illustrated in FIG. 3, in one or more embodiments, the sketch to layered-digital-design system 106 utilizes an equalization model as part of the binarization model 308. In one or more implementations, an equalization model redistributes pixel intensity values of a digital image. Specifically, an equalization model adjusts an intensity histogram to ensure that pixel values are spread more evenly across the available range of intensities to improve visibility of details in both bright and dark regions of a digital image. In one or more embodiments, an equalization model includes adaptive histogram equalization, contrast limited adaptive histogram equalization, global histogram equalization, etc. In particular, in one or more implementations, the sketch to layered-digital-design system 106 utilizes a histogram equalization model 312 (e.g., which utilizes contrast limited histogram equalization) to normalize the lighting and/or enhance the contrast of the sketch image 302. In one or more embodiments, the histogram equalization model 312 includes utilizing a tile size of 17×17 and a clip limit of 1.0.

As also depicted in FIG. 3, in one or more implementations, the sketch to layered-digital-design system 106 performs adaptive thresholding 314 as part of the binarization model 308. In one or more embodiments, adaptive thresholding includes determining a threshold value for regions of a digital image to convert the digital image to a binary format. For instance, in one or more implementations, the sketch to layered-digital-design system 106 performs adaptive thresholding via a gaussian average, mean or median adaptive thresholding, etc. Specifically, in one or more embodiments, the sketch to layered-digital-design system 106 utilizes a gaussian average method of adaptive thresholding on a neighborhood size equal to ¼ of the smaller image dimension to convert the sketch image 302 to a binary format.

As further illustrated in FIG. 3, in one or more implementations, the sketch to layered-digital-design system 106 performs morphological closing 316 as part of the binarization model 308. In one or more embodiments, morphological closing removes small holes, gaps, and/or other discontinuities in a binary digital image. For example, in one or more implementations, morphological closing removes the discontinuities while preserving the overall shape and size of objects in the digital image. In particular, in one or more embodiments, the sketch to layered-digital-design system 106 performs the morphological closing 316 using a 5×5 kernel to remove small holes and/or gaps in the sketch image 302 to generate the clean sketch image 318. In one or more implementations, the sketch to layered-digital-design system 106 utilizes the morphological closing 316 in connection with the adaptive thresholding to remove the holes and/or gaps in the binary format of the clean sketch image 318 prior to generating a compositional reference 330 (e.g., compositional reference 206) from the clean sketch image 318.

As additionally shown in FIG. 3, in one or more embodiments, the sketch to layered-digital-design system 106 performs an act 320 of generating a compositional reference 330. Specifically, in one or more implementations, the sketch to layered-digital-design system 106 generates the compositional reference 330 from the clean sketch image 318. For example, in one or more embodiments, the sketch to layered-digital-design system 106 extracts text strings from the clean sketch image 318 utilizing an optical character recognition (OCR) model 322. In one or more implementations, the OCR model 322 recognizes and extracts text information (e.g., alpha numeric characters) from a digital image. In particular, in one or more embodiments, the sketch to layered-digital-design system 106 utilizes the OCR model 322 to determine text bounding boxes 324 about the text of the sketch image 302. Moreover, in one or more implementations, the sketch to layered-digital-design system 106 uses the text bounding boxes 324 to extract the text strings corresponding to the text bounding boxes 324. To illustrate, the sketch to layered-digital-design system 106 determines bounding boxes about “Fright,” “this,” “Way!,” etc. from the clean sketch image and extracts corresponding text strings.

As further illustrated in FIG. 3, in one or more embodiments, the sketch to layered-digital-design system 106 performs a morphological opening operation 326 as part of the act 320 of generating the compositional reference 330. Specifically, in one or more implementations, the sketch to layered-digital-design system 106 generates filled contours of characters (e.g., the letters, numbers, punctuation, etc.) of the text images in the clean sketch image 318. In these or other embodiments, the sketch to layered-digital-design system 106 performs the morphological opening operation 326 for each identified text image according to the determined text bounding boxes 324.

As also depicted in FIG. 3, in one or more embodiments, the sketch to layered-digital-design system 106 utilizes a font detection model 328 as part of the act 320 of generating the compositional reference 330. In one or more implementations, the font detection model 328 determines the font by predicting the most similar-looking font name based on visual characteristics of the text in the clean sketch image 318. In particular, the sketch to layered-digital-design system 106 determines fonts of the text strings based on the text (in image format) of the clean sketch image 318. For instance, in one or more embodiments, the sketch to layered-digital-design system 106 determines the fonts of the text strings based on the characters with filled contours according to the morphological opening operation 326.

In one or more implementations, the font detection model 328 uses a classifier neural network to extract an image embedding vector from a text region of the clean sketch image 318 and one or more font embedding vectors for one or more unlearned fonts (e.g., fonts stored locally on a client device). Further, in one or more embodiments, the font detection model 328 compares the image embedding vector and the one or more font embedding vectors of the unlearned font(s) to generate a set of similarity scores indicating the similarity of the font of the text region to the one or more unlearned fonts. Based on the set of similarity scores, in one or more embodiments, the font detection model 328 determines the font for the text region (e.g., by selecting the font corresponding to the highest similarity score).

In one or more embodiments, in addition to the image embedding vector and the one or more font embedding vectors of the unlearned font(s), the font detection model 328 extracts one or more font embedding vectors for one or more learned fonts (e.g., fonts on which the classifier neural network is trained). Moreover, in one or more implementations, the font detection model 328 compares the image embedding vector with the font embedding vector(s) of the unlearned font(s) and the one or more font embedding vector(s) of the learned font(s) to generate a set of similarity scores indicating the similarity of the font of the text region to the one or more unlearned fonts and the one or more learned fonts. Furthermore, in one or more embodiments, the font detection model 328 determines the font for the text region from among top ranked learned or unlearned fonts based on the set of similarity scores (e.g., by selecting the font corresponding to the highest similarity score).

In one or more implementations, the font detection model 328 re-ranks one or more fonts with high similarity scores by comparing these top ranked fonts with additional font embedding vectors representing the text region of the clean sketch image 318 stylized according to the top ranked learned and/or unlearned fonts. For example, the font detection model 328 generates additional digital images including the text of the text region in the style of the top ranked fonts rendered against a background. Further, the font detection model 328 extracts an image embedding vector for each rendered image and compares them with the image embedding vector of the text region in the clean sketch image 318 to generate an additional set of similarity scores. Moreover, the font detection model 328 re-ranks the top ranked fonts based on the additional similarity scores comparing the font embedding vector to the image embedding vector. In these or other embodiments, the font detection model 328 determines the font for the text region from among the learned or unlearned fonts based on the additional set of similarity scores (e.g., by selecting the font with the highest similarity score based on the re-ranking).

Furthermore, in one or more implementations, the sketch to layered-digital-design system 106 utilizes a font size model as part of the act 320 of generating the compositional reference 330. Specifically, the sketch to layered-digital-design system 106 utilizes the font size model to determine the font sizes of the text strings based on the text in the clean sketch image 318. For example, in one or more embodiments, the sketch to layered-digital-design system 106 performs a binary search across a range of font sizes that can fit inside the clean sketch image 318 to identify the size that most closely matches the dimensions of the text bounding boxes.

As further illustrated in FIG. 3, in one or more implementations, the sketch to layered-digital-design system 106 generates the compositional reference 330. In particular, in one or more embodiments, the sketch to layered-digital-design system 106 generates the compositional reference 330 based on the text strings, the determined fonts of the text strings, and the determined sizes of the text strings. For instance, in one or more implementations, the sketch to layered-digital-design system 106 generates editable text elements 332 with the determined text strings, fonts, and sizes. Additionally, in one or more embodiments, the sketch to layered-digital-design system 106 renders the compositional reference by replacing the text (in image format) of the clean sketch image with the editable text elements 332. For example, in one or more implementations, the sketch to layered-digital-design system 106 generates the compositional reference 330 according to Algorithm (1):

Algorithm 1 Sketch Binarization

1. Input: Image im, CLAHE tile grid size clahe TileGridSize, morphological kernel size
morph_kernel_size
2. min_dim ← min(im.shape)
$3. blockSize ← ⌊ \frac{min\_dim}{4} ⌋ + ( ⌊ \frac{min\_dim}{4} ⌋ mod 2 = 0 )$
4. im ← Apply CLAHE with clip limit 1.0 and tile grid size claheTileGridSize to im
5. im ← Apply adaptive thresholding using gaussian neighbourhood of blockSize
6. im ← ~ (morphologyClose(~im, morph_kernel_size))
7. im ← Recognize and Reconstruct Text(im)
8. Return im

As mentioned previously, in one or more embodiments, the sketch to layered-digital-design system 106 generates a digitized digital design based on a compositional reference. Indeed, in one or more implementations, the sketch to layered-digital-design system 106 generates the digitized digital design from the compositional reference utilizing one or more machine learning models (e.g., including deep learning). FIG. 4 illustrates a diagram of the sketch to layered-digital-design system 106 generating a digitized digital design of a sketch image in accordance with one or more embodiments.

As portrayed in FIG. 4, in one or more embodiments, the sketch to layered-digital-design system 106 generates a digitized digital design 420 of a sketch image based on a compositional reference (e.g., compositional reference 206) utilizing one or more machine learning models. Specifically, in one or more implementations, the sketch to layered-digital-design system 106 utilizes the compositional reference 402 (e.g., compositional reference 206) and a vision-language model (VLM) 404 to generate text-to-image prompts 406. In one or more embodiments, a VLM includes a machine learning model designed to process and understand both visual inputs and text inputs. In particular, a VLM combines computer vison or techniques for image analysis with natural language processing to interpret and generate text. Specifically, the VLM includes one or more of a Large Language and Vision Assistant (LLaVa) model, a Contrastive Language-Image Pretraining (CLIP) model, or other similar models.

As noted previously, in one or more implementations, the sketch to layered-digital-design system 106 utilizes the VLM 404 to generate text-to-image prompts 406 based on the compositional reference 402. In particular, the sketch to layered-digital-design system 106 generates one or more text-to-image prompts 406 based on the image information and the editable text elements of the compositional reference. To illustrate, the sketch to layered-digital-design system 106 generates a text-to-image prompt 406 reading “a poster for a Halloween party held on 15^{th} October” based on the editable text elements and image elements of the compositional reference.

Further, in one or more embodiments, the sketch to layered-digital-design system 106 generates the text-to-image prompts 406 for use with a text encoder 408. In one or more implementations, a text encoder includes a machine learning model that converts text into a numerical representation (e.g., a text embedding). Specifically, a text encoder captures the semantic meaning, syntax, and relationships between words or phrases in a high-dimensional vector space.

As additionally shown in FIG. 4, in one or more embodiments, the sketch to layered-digital-design system 106 utilizes the text encoder 408 to generate text embeddings 410 based on the compositional reference 402. In particular, the sketch to layered-digital-design system 106 generates the text embeddings 410 from the text-to-image prompts 406. For instance, in one or more implementations, the sketch to layered-digital-design system 106 generates the text embeddings 410 for use with a deep learning model. To illustrate, in one or more embodiments, the sketch to layered-digital-design system 106 utilizes the text embeddings 410 to condition a diffusion model 412. For example, the sketch to layered-digital-design system 106 conditions the diffusion model 412 by utilizing the text embeddings 410 as input data to the layers of the diffusion model 412.

In one or more implementations, a diffusion model includes a generative neural network that generates new data with features similar to features found in training data. For example, the diffusion model 412 includes a generative adversarial neural network or a diffusion model that generates digital images. For instance, the generative machine learning model includes a diffusion model such as that described herein below. In one or more implementations, the sketch to layered-digital-design system 106 trains the diffusion model 412 by iteratively adding noise 414 to the input data during a forward process and then recovering the data by denoising the data during a reverse process.

As further illustrated in FIG. 4, in one or more embodiments, the sketch to layered-digital-design system 106 utilizes an image encoder 416 to generate image embeddings 418 from the compositional reference 402. In one or more implementations, an image encoder includes a machine learning model that converts visual input, such as images, into numerical representations (e.g., image embeddings). In particular, the image encoder 416 processes the image components of the compositional reference 402 through layers of the image encoder 416 to capture features like edges, textures, and high-level semantics in the image embeddings 418.

As also depicted in FIG. 4, in one or more embodiments, the sketch to layered-digital-design system 106 utilizes the image encoder 416 to generate the image embeddings for conditioning the diffusion model 412. Specifically, the sketch to layered-digital-design system 106 utilizes the image embeddings 418 as input data to the layers of the diffusion model 412. For instance, in one or more implementations, the sketch to layered-digital-design system 106 conditions the diffusion model 412 utilizing the image embeddings 418 as input into the initial layers of the diffusion model 412. To illustrate, the sketch to layered-digital-design system 106 utilizes a first image embedding output from a first layer of the image encoder 416 as input data to the first layer of the diffusion model 412, a second image embedding output from the second layer of the image encoder 416 as input data to the second layer of the diffusion model 412, etc., as shown in FIG. 4.

As further illustrated in FIG. 4, in one or more embodiments, the sketch to layered-digital-design system 106 utilizes the diffusion model 412 to generate the digitized digital design 420. In particular, the sketch to layered-digital-design system 106 generates the digitized digital design 420 of the sketch image by conditioning the diffusion model 412 on at least one of the text embeddings 410 or the image embeddings 418. For example, in one or more implementations, the sketch to layered-digital-design system 106 generates the digitized digital design 420 as a digital image, such as a raster image. Indeed, in one or more embodiments, the sketch to layered-digital-design system 106 generates the digitized digital design 420 to include an image with design elements such as images and text elements. To illustrate, the sketch to layered-digital-design system 106 generates the digitized digital design 420 as a digital image including design elements (e.g., an owl, the moon, trees, clouds) and text elements from the editable text elements of the compositional reference 402 (e.g., “Fright,” “this,” “Way!,” etc.).

As previously mentioned, in one or more implementations, the sketch to layered-digital-design system 106 generates a background layer of a digital design document based on a digitized digital design of the sketch image. Indeed, in one or more embodiments, the sketch to layered-digital-design system 106 utilizes a segmentation model and/or an inpainting model to generate the background layer from the digitized digital design. FIG. 5 illustrates a diagram of the sketch to layered-digital-design system 106 generating a background layer of a digital design document from a digitized digital design in accordance with one or more embodiments.

As depicted in FIG. 5, in one or more implementations, the sketch to layered-digital-design system 106 generates a background layer 510 (e.g., background layer 210) based on a digitized digital design 502 (e.g., digitized digital design 208) utilizing a segmentation model 504. In one or more embodiments, a segmentation model includes a computer vision model that divides a digital image into distinct regions based on specific characteristics and/or based on text bounding boxes. For instance, the sketch to layered-digital-design system 106 utilizes the segmentation model 504 to identify and isolate text regions (i.e., regions containing text) from background or other image elements.

Specifically, in one or more implementations, the sketch to layered-digital-design system 106 extracts text regions from the digitized digital design 502. For example, in one or more embodiments, the sketch to layered-digital-design system 106 extracts the text regions based on text bounding boxes 506. Indeed, in one or more implementations, the sketch to layered-digital-design system 106 extracts the text regions based on the text bounding boxes 506 (e.g., text bounding boxes 324) determined utilizing the OCR model as discussed previously. In these or other embodiments, the sketch to layered-digital-design system 106 identifies and extracts the regions of the digitized digital design 502 corresponding to these text bounding boxes.

As additionally shown in FIG. 5, in one or more embodiments, the sketch to layered-digital-design system 106 generates the background layer 510 utilizing an inpainting model 508. In one or more implementations, an inpainting model includes a method for restoring or filling missing or blank regions of a digital image by predicting plausible content. In particular, an inpainting model predicts plausible content by analyzing the context surrounding the missing or blank regions of the digital image and learning patterns, textures, and structures to generate realistic replacements for the missing regions.

Specifically, in one or more embodiments, the sketch to layered-digital-design system 106 utilizes the inpainting model 508 to inpaint blank regions corresponding to the extracted text regions of the digitized digital design 502. For instance, the sketch to layered-digital-design system 106 generates the complete background layer 510 by inpainting these blank regions. To illustrate, the sketch to layered-digital-design system 106 fills the extracted region corresponding to the text region with the word “Fright” with orange colored sky, parts of tree branches, clouds, etc. based on the surrounding context. Moreover, in one or more implementations, the sketch to layered-digital-design system 106 samples the text color for reconstruction.

In one or more embodiments, the inpainting model 508 is a diffusion neural network. In particular, (to prepare/initiate a diffusion neural network) a diffusion neural network receives as input a digital image and adds noise to the digital image through a series of steps. For instance, the sketch to layered-digital-design system 106 via the diffusion neural network maps a portion of a digital image to a latent space utilizing a fixed Markov chain that adds noise to the data of the digital image. Furthermore, each step of the fixed Markov chain relies upon the previous step. Specifically, at each step, the fixed Markov chain adds Gaussian noise with variance which produces a diffusion representation (e.g., diffusion latent vector, a diffusion noise map, or a diffusion inversion).

Subsequent to adding noise to the digital image at various steps of the diffusion neural network, the sketch to layered-digital-design system 106 utilizes a denoising neural network to recover the original data from the digital image. Specifically, the sketch to layered-digital-design system 106 utilizes a denoising neural network with a length T equal to the length of the fixed Markov chain to reverse the process of the fixed Markov chain. In particular, the denoising neural network reconstructs the digital image without the masked portion and replaces the masked portion with inpainted pixels that conform with the remainder of the digital image. In other words, the sketch to layered-digital-design system 106 trains the denoising neural network to remove noised data and replace the noised data with inpainted pixels. Accordingly, after training, the sketch to layered-digital-design system 106 implements a trained diffusion neural network to generate inpainted pixels.

As mentioned above, the sketch to layered-digital-design system 106 generates inpainted pixels for a digital image based on a region in the digital image being indicated by a mask or some other input (e.g., a digital sketch). For example, the region includes a portion of an initial digital image to modify. In some instances, the region includes one or more objects within the digital image. For example, an object includes a collection of pixels in a digital image that depicts a person, place, or thing. To illustrate, in some embodiments, an object includes a person, an item, a natural object (e.g., a tree or rock formation) or a structure depicted in a digital image.

As previously noted, in one or more embodiments, the sketch to layered-digital-design system 106 generates a layered digital design document of the sketch image. Indeed, in one or more implementations, the sketch to layered-digital-design system 106 generates the layered digital design document including the background layer and reconstructed editable text elements. FIG. 6 illustrates a diagram of the sketch to layered-digital-design system 106 generating a layered digital design document of the sketch image in accordance with one or more embodiments.

As illustrated in FIG. 6, in one or more embodiments, the sketch to layered-digital-design system 106 generates a layered digital design document 608 (e.g., digital design document 212) of the text image. In particular, the sketch to layered-digital-design system 106 generates the layered digital design document 608 to include the background layer 602 (e.g., background layer 210). In these or other embodiments, the sketch to layered-digital-design system 106 utilizes the background layer 602 based on the digitized digital design as described above with respect to FIG. 5. In addition, in one or more implementations, the sketch to layered-digital-design system 106 generates the layered digital design document 608 to include on editable text elements 606 based on the compositional reference.

As further illustrated in FIG. 6, in one or more embodiments, the sketch to layered-digital-design system 106 generates the layered digital design document 608 by applying layered vectorization 604. In one or more implementations, layered vectorization includes segmenting individual visual elements (e.g., image elements, editable text elements, etc.) within the layered digital design document 608 and filling the backgrounds of the visual elements. Specifically, in one or more embodiments, the sketch to layered-digital-design system 106 applies layered vectorization 604 to generate the layered digital design document 608 by overlaying the editable text elements 606 on the background layer 602.

As just mentioned, in one or more implementations, the sketch to layered-digital-design system 106 overlays the editable text elements 606 on the background layer 602. In particular, the sketch to layered-digital-design system 106 overlays the editable text elements 606 on the background layer 602 based on the visual elements of the background layer 602. For example, the sketch to layered-digital-design system 106 overlays the editable text elements 606 by placing each editable text element to complement the underlying visual elements (e.g., the owl, the moon, the trees, the clouds, etc.) of the background layer 602 resulting in a cohesive final design of the layered digital design document 608.

Furthermore, in one or more embodiments, the sketch to layered-digital-design system 106 reconstructs the editable text elements 606. Specifically, the sketch to layered-digital-design system 106 utilizes the editable text elements 606 (e.g., editable text elements 332) generated for the compositional reference. For instance, the sketch to layered-digital-design system 106 reconstructs the editable text elements 606 by applying the correct color to each editable text element 606 based on the text color sampling described above. Additionally, in one or more implementations, the sketch to layered-digital-design system 106 fills the background of the editable text elements 606 to match the surrounding background. In these or other embodiments, the sketch to layered-digital-design system 106 generates the layered digital design document 608 to include two layers; one for the background layer 602 and one for the overlayed editable text elements 606.

Further, in one or more embodiments, the sketch to layered-digital-design system 106 applies layered vectorization 604 by segmenting a visual element of the background layer 602 and filling the background of the visual element. To illustrate, in one or more implementations, the sketch to layered-digital-design system 106 segments the owl and/or the moon and fills the background of these image elements to generate a complete visual element. For example, in one or more embodiments, the sketch to layered-digital-design system 106 arranges the visual elements to complement underlying visuals of the background layer 602.

Turning to FIG. 7, additional detail will now be provided regarding various components and capabilities of the sketch to layered-digital-design system 106. In particular, FIG. 7 illustrates an example schematic diagram of a computing device 700 (e.g., the server device(s) 102 and/or the client device(s) 110) implementing the sketch to layered-digital-design system 106 in accordance with one or more embodiments of the present disclosure for components 702-710. As illustrated in FIG. 7, the sketch to layered-digital-design system 106 includes a sketch manager 702, a digitized digital design generator 704, a background manager 706, a digital design document generator 708, and a storage manager 710.

The sketch manager 702 accesses and/or receives a sketch image and generates a compositional reference of the sketch image. In particular, the sketch manager 702 determines a canvas size and/or an aspect ratio of the sketch image. Moreover, the sketch manager 702 generates a clean sketch image utilizing a binarization model based on the canvas size and/or aspect ratio of the sketch image. Furthermore, in one or more implementations, the sketch manager 702 generates a compositional reference from the clean sketch image using various text reconstruction models such as an OCR model, a font detection model, a font size model, a morphological opening operation, etc. Additionally, the sketch manager 702 interacts with other components to pass the compositional reference for further processing.

The digitized digital design generator 704 generates a digitized digital design of the sketch image based on the compositional reference. Specifically, the digitized digital design generator 704 receives the compositional reference from the sketch manager 702 and utilizes the compositional reference with one or more machine learning models 114 to generate the digitized digital design of the sketch image. For instance, digitized digital design generator 704 utilizes the machine learning models 114 to generate text embeddings based on the text of the compositional reference. Further, the digitized digital design generator 704 utilizes an image encoder to generate image embeddings from the compositional reference. Moreover, the digitized digital design generator 704 generates the digitized digital design of the sketch image by conditioning a diffusion model on the text embeddings and/or the image embeddings. Furthermore, the digitized digital design generator 704 interacts with other components to pass the digitized digital design for further processing.

The background manager 706 generates a background layer based on the digitized digital design. In particular, the background manager 706 generates the background layer by extracting text regions of the digitized digital design utilizing a segmentation model. Additionally, the background manager 706 utilizes an inpainting model to inpaint regions of the digitized digital design corresponding to the extracted text regions to generate a complete background layer. Further, the background manager 706 interacts with other components to pass the complete background layer for further processing.

The digital design document generator 708 generates a digital design document. Specifically, the digital design document generator 708 generates a layered digital design document including the background layer. Moreover, the digital design document generator 708 generates the layered digital design document to include editable text elements based on the compositional reference. For example, digital design document generator 708 overlays the editable text elements on the background layer as part of generating the layered digital design document.

The sketch to layered-digital-design system 106 includes a storage manager 710. In one or more implementations, the storage manager 710 stores information (e.g., via one or more memory devices) on behalf of the sketch to layered-digital-design system 106. For example, the storage manager 710 includes a database for storing sketch images, clean sketch images, text bounding boxes, editable text elements, compositional references, text-to-image prompts, text embeddings, image embeddings, digitized digital designs, and/or background layers.

In one or more embodiments, each of the components 702-710 of the sketch to layered-digital-design system 106 include software, hardware, or both. For example, the components 702-710 include one or more instructions stored on a computer-readable storage medium and executable by processors of one or more computing devices, such as a client device or server device. When executed by the one or more processors, the computer-executable instructions of the sketch to layered-digital-design system 106 cause the computing device(s) to perform the methods described herein. Alternatively, the components 702-710 include hardware, such as a special-purpose processing device to perform a certain function or group of functions. Alternatively, the components 702-710 of the sketch to layered-digital-design system 106 include a combination of computer-executable instructions and hardware.

Furthermore, the components 702-710 of the sketch to layered-digital-design system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 702-710 of the sketch to layered-digital-design system 106 are implemented as a stand-alone application, such as a desktop or mobile application. Furthermore, in various embodiments, the components 702-710 of the sketch to layered-digital-design system 106 are implemented as one or more web-based applications hosted on a remote server. Alternatively, or additionally, the components 702-710 of the sketch to layered-digital-design system 106 are implemented in a suite of mobile device applications or “apps.” For example, in one or more embodiments, the sketch to layered-digital-design system 106 comprises or operates in connection with digital software applications such as ADOBE® ACROBAT®, ADOBE® EXPRESS®, ADOBE® ILLUSTRATOR® CREATIVE CLOUD®, ADOBE® INDESIGN® CREATIVE CLOUD®, and/or ADOBE® PHOTOSHOP® CREATIVE CLOUD®.

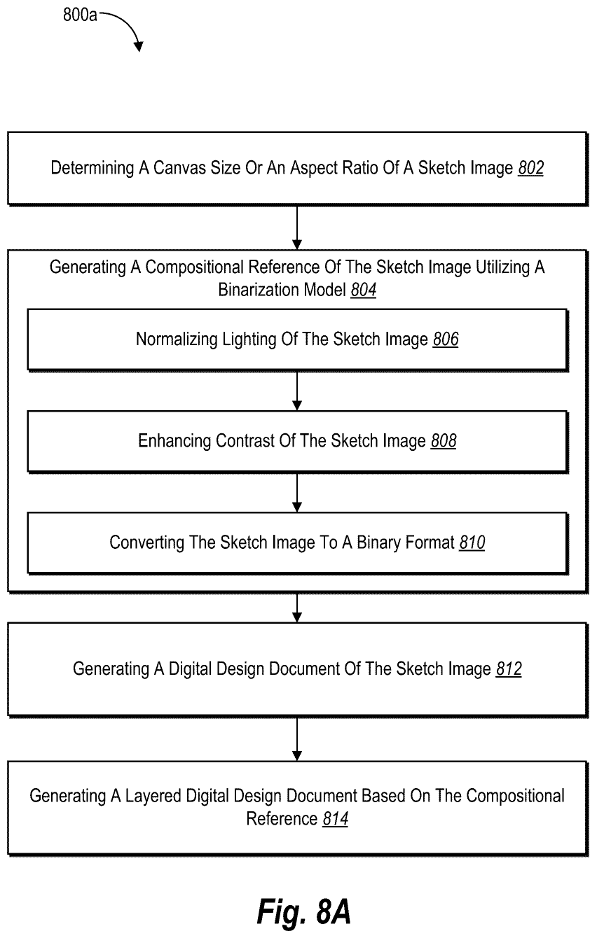

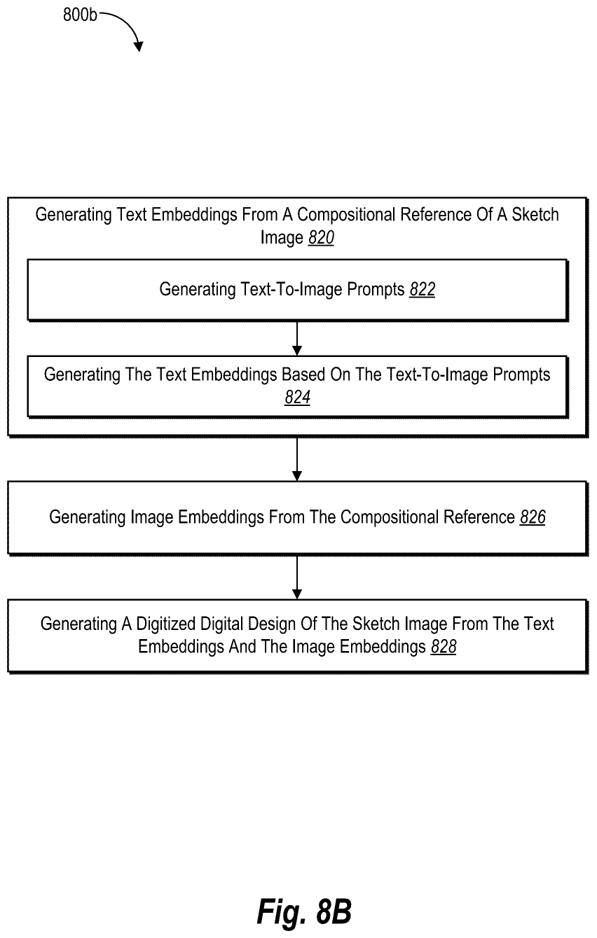

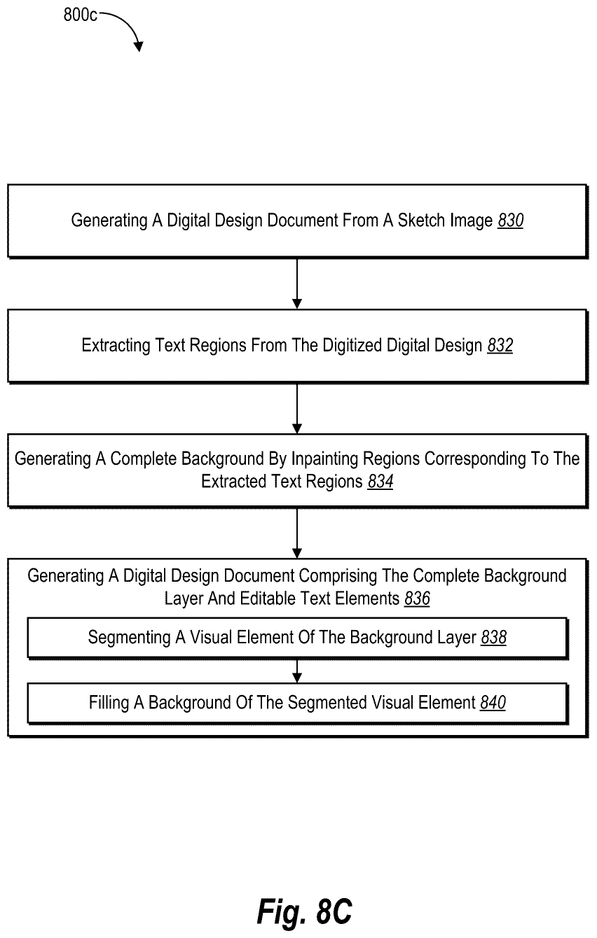

FIGS. 1-7, the corresponding text, and the examples provide a number of different systems, methods, and non-transitory computer readable media for generating layered digital designs from sketches using deep learning. In addition to the foregoing, embodiments can also be described in terms of flowcharts comprising acts for accomplishing a particular result. For example, FIGS. 8A-8C illustrate flowcharts of example sequences of acts in accordance with one or more embodiments.

While FIGS. 8A-8C illustrate acts according to one or more embodiments, alternative embodiments may omit, add to, reorder, and/or modify any of the acts shown in FIGS. 8A-8C. The acts of FIGS. 8A-8C can be performed as part of a method. Alternatively, a non-transitory computer readable medium can comprise instructions, that when executed by one or more processors, cause a computing device to perform the acts of FIGS. 8A-8C. In still further embodiments, a system can perform the acts of FIGS. 8A-8C. Additionally, the acts described herein may be repeated or performed in parallel with one another or in parallel with different instances of the same or other similar acts.

FIG. 8A illustrates an example series of acts 800a for generating a layered digital design document based on a compositional reference of a sketch image. The series of acts 800a can include an act 802 of determining a canvas size or an aspect ratio of a sketch image; an act 804 of generating a compositional reference of the sketch image utilizing a binarization model; an act 806 of normalizing lighting of the sketch image; an act 808 of enhancing contrast of the sketch image; an act 810 of converting the sketch image to a binary format; an act 812 of generating a digital design document of the sketch image; and an act 814 of generating a layered digital design document based on the compositional reference.

In one or more embodiments, the act 802 includes determining at least one of a canvas size or an aspect ratio of a sketch image. In one or more embodiments, the acts 804 and 806 also include an act of generating, based on the at least one of the canvas size or the aspect ratio, a compositional reference of the sketch image utilizing a binarization model by normalizing lighting of the sketch image. In one or more implementations, the act 808 further includes an act of enhancing contrast of the sketch image. Additionally, in one or more embodiments, the act 810 includes an act of converting the sketch image to a binary format. In one or more implementations, the act 812 also includes an act of generating, utilizing one or more machine learning models, a digitized digital design of the sketch image based on the compositional reference. In one or more embodiments, the act 814 further includes an act of generating a layered digital design document including a background layer based on the digitized digital design and editable text elements based on the compositional reference.

In one or more implementations, generating the compositional reference of the sketch image utilizing the binarization model further includes utilizing a smoothing model to smooth noise of the sketch image. In one or more embodiments, generating the compositional reference of the sketch image utilizing the binarization model includes utilizing a histogram equalization model to normalize the lighting and enhance the contrast of the sketch image. In one or more implementations, generating the compositional reference of the sketch image utilizing the binarization model includes utilizing adaptive thresholding to convert the sketch image to the binary format. In one or more embodiments, generating the compositional reference of the sketch image utilizing the binarization model further includes utilizing morphological closing to remove at least one of a hole or a gap in the binary format of the compositional reference.

In one or more implementations, generating, utilizing the one or more machine learning models, the digitized digital design of the sketch image based on the compositional reference includes generating, utilizing a text encoder, text embeddings based on the compositional reference of the sketch image. Additionally, in one or more implementations, the series of acts 800a includes an act of generating, utilizing an image encoder, image embeddings from the compositional reference of the sketch image. In one or more embodiments, the series of acts 800a also includes an act of generating, utilizing a diffusion model, the digitized digital design of the sketch image by conditioning the diffusion model on the text embeddings and the image embeddings.

In one or more embodiments, generating the text embeddings based on the compositional reference of the sketch image includes generating, utilizing a vision-language model and the compositional reference, one or more text-to-image prompts. In one or more implementations, the series of acts 800a further includes an act of generating, utilizing the text encoder, the text embeddings from the one or more text-to-image prompts.

FIG. 8B illustrates an example series of acts 800b for generating a digitized digital design utilizing a deep learning model based on image embeddings and text embeddings generated from a compositional reference of a sketch image. The series of acts 800b can include an act 820 of generating text embeddings from a compositional reference of a sketch image; an act 822 of generating text-to-image prompts; an act 824 of generating the text embeddings based on the text-to-image prompts; an act 826 of generating image embeddings from the compositional reference; and an act 828 of generating a digitized digital design of the sketch image from the text embeddings and the image embeddings.

In one or more implementations, the act 820 includes generating, utilizing one or more machine learning models, text embeddings from a compositional reference of a sketch image. Additionally, in one or more embodiments, the act 826 includes an act of generating, utilizing an image encoder, image embeddings from the compositional reference of the sketch image. In one or more implementations, the act 828 also includes an act of generating, utilizing a diffusion model, a digitized digital design of the sketch image by conditioning the diffusion model on the text embeddings and the image embeddings.

In one or more embodiments, generating the text embeddings from the compositional reference of the sketch image includes generating, utilizing a vision-language model and the compositional reference, one or more text-to-image prompts. In one or more embodiments, the series of acts 800b further includes an act of generating, utilizing a text encoder, the text embeddings from the one or more text-to-image prompts.

In one or more implementations, the series of acts 800b includes generating, utilizing a binarization model, a clean sketch image of the sketch image. Additionally, in one or more implementations, the series of acts 800b includes an act of extracting, utilizing an optical character recognition model, a text string from the clean sketch image. In one or more embodiments, the series of acts 800b also includes an act of determining, utilizing a font detection model, a font of the text string based on text of the clean sketch image. In one or more implementations, the series of acts 800b further includes an act of generating, based on the text string and the font of the text string, an editable text element.

In one or more embodiments, determining the font of the text string based on the text of the clean sketch image includes generating filled contours of characters of the text string utilizing a morphological opening operation. In one or more implementations, the series of acts 800b includes determining a font size of the text string based on the text of the clean sketch image. In one or more embodiments, the series of acts 800b includes generating a digital design document based on the digitized digital design of the sketch image. In one or more implementations, generating the digital design document based on the digitized digital design of the sketch image includes generating a background layer based on the digitized digital design. Additionally, in one or more embodiments, the series of acts 800b includes an act of overlaying one or more editable text elements on the background layer.

FIG. 8C illustrates an example series of acts 800c for generating a layered digital design document including a background layer and editable text elements. The series of acts 800c can an act 830 of generating a digital design document from a sketch image; an act 832 of extracting text regions from the digitized digital design; an act 834 of generating a complete background by inpainting regions corresponding to the extracted text regions; an act 836 of generating a digital design document comprising the complete background layer and editable text elements; an act 838 of segmenting a visual element of the background layer; and an act 840 of filling a background of the segmented visual element.

In one or more embodiments, the act 830 includes generating, utilizing a diffusion model, a digitized digital design from a sketch image. In one or more implementations, the act 832 also includes an act of extracting, utilizing a segmentation model, text regions from the digitized digital design. In one or more embodiments, the act 834 further includes an act of generating, utilizing an inpainting model, a complete background layer by inpainting regions corresponding to the extracted text regions of the digitized digital design. Additionally, in one or more implementations, the act 836 includes an act of generating a digital design document including the complete background layer and one or more editable text elements.

In one or more implementations, generating the digital design document includes applying layered vectorization to the complete background layer by segmenting a visual element of the complete background layer. In one or more embodiments, the series of acts 800c also includes an act of filling a background of the segmented visual element to generate a complete visual element. In one or more embodiments, generating the digital design document includes overlaying the one or more editable text elements based on one or more visual elements of the complete background layer.

In one or more implementations, the series of acts 800c includes generating a clean sketch image of the sketch image based on at least one of a canvas size or an aspect ratio of the sketch image. In one or more implementations, the series of acts 800c further includes an act of determining, utilizing an optical character recognition model, one or more text bounding boxes from the clean sketch image of the sketch image. Additionally, in one or more embodiments, the series of acts 800c includes an act of wherein extracting, utilizing the segmentation model, the text regions from the digitized digital design includes utilizing the segmentation model to extract the text regions based on the one or more text bounding boxes.

In one or more embodiments, the series of acts 800c includes generating a compositional reference of the sketch image utilizing a binarization model. In one or more implementations, the series of acts 800c also includes an act of wherein generating, utilizing the diffusion model, the digitized digital design from the sketch image includes conditioning the diffusion model on at least one of a set of text embeddings or a set of image embeddings based on the compositional reference.

In one or more implementations, generating the compositional reference of the sketch image utilizing the binarization model includes utilizing a histogram equalization model to normalize a lighting and enhance a contrast of the sketch image. In one or more embodiments, the series of acts 800c further includes an act of utilizing adaptive thresholding to convert the sketch image to a binary format.

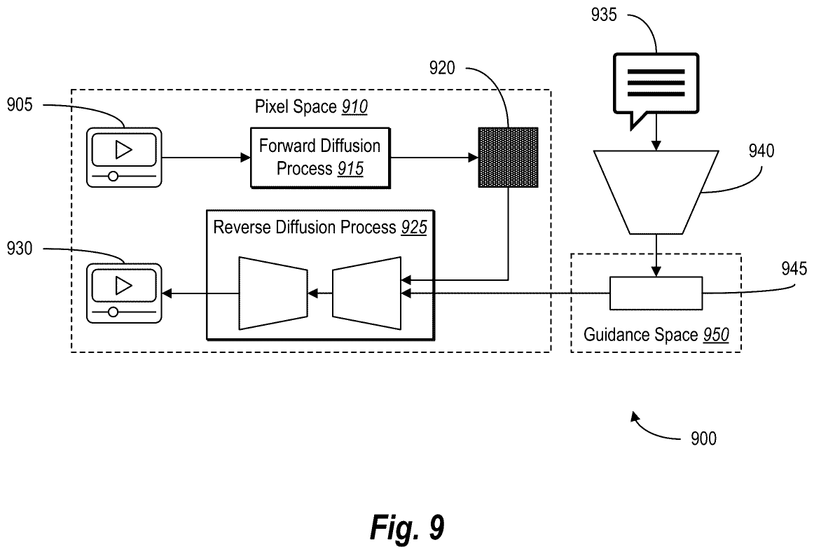

FIG. 9 shows an example of a diffusion model 900 according to aspects of the present disclosure. In some examples, a diffusion model 900 describes the operation and architecture of a generative diffusion model (e.g., diffusion inpainting model). The diffusion model 900 depicted in FIG. 9 is an example of, or includes aspects of, the sketch to layered-digital-design system 106 as described herein. Accordingly, FIG. 9 shows the sketch to layered-digital-design system 106 initializing a trained generative diffusion model by leveraging a forward diffusion process to destroy data and then creating media (e.g., inpainted pixels to replace a region in a digital image) from the destroyed data using a denoising process. In other words, the sketch to layered-digital-design system 106 teaches a generative diffusion model to create generative content from noise using a forward diffusion process and a denoising process.

As an example, diffusion models are generative models that operate by progressively destroying/noising an input signal and learning to reverse the destroyed data to generate new samples. In particular, diffusion models use a forward diffusion process to add noise over a series of timesteps and a reverse diffusion process to remove noise over a number of timesteps corresponding to the forward number of steps.

Next, a reverse diffusion process 925 (e.g., a U-Net) gradually removes the noise from a noisy media item 920 at the various noise levels to obtain an output media item 930. In some cases, an output media item 930 is created from each of the various noise levels. The output media item 930 can be compared to the original media item 905 to train the reverse diffusion process 925.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, image inpainting, and media manipulation.

Diffusion models work by iteratively adding noise to the data during a forward process and then learning to recover the data by denoising the data during a reverse process. For example, during training, a guided latent diffusion model may take an original media item 905 in a pixel space 910 as input and apply forward diffusion process 915 to gradually add noise to the original media item 905 to obtain noisy media item 920 at various noise levels.

The reverse diffusion process 925 can also be guided based on a text prompt 935 (e.g., inpainting request), or another guidance prompt, such as an image, a layout, a segmentation map, etc. The text prompt 935 can be encoded using a text encoder 940 (e.g., an encoder that can also be a multimodal encoder) to obtain guidance features 945 in guidance space 950. The guidance features 945 can be combined with the noisy media item at one or more layers of the reverse diffusion process 925 to ensure that the output media item 930 includes content described by the text prompt 935. For example, the guidance features 945 can be combined with the noisy features using a cross-attention block within the reverse diffusion process 925.

In one or more embodiments, methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

In one or more embodiments, the sketch to layered-digital-design system 106 utilizes a diffusion process to adds noise to data in the pixel space 910. Furthermore, FIG. 9 shows the sketch to layered-digital-design system 106 utilizing the forward diffusion process 915 to add noise to the data. Moreover, FIG. 9 shows the sketch to layered-digital-design system 106 utilizing a denoising process to remove noise from noised data. For instance, the sketch to layered-digital-design system 106 utilizes a decoder to generate the output media item 930. Further, in one or more embodiments, the sketch to layered-digital-design system 106 adds noise to data in a progressive manner (e.g., over a number of timesteps corresponding to a number of diffusion steps). In doing so, the sketch to layered-digital-design system 106 trains a diffusion model to create generative content from destroyed data (e.g., the noised data).

In one or more embodiments, the sketch to layered-digital-design system 106 uses a diffusion transformer model as the diffusion inapainting model. For instance, the sketch to layered-digital-design system 106 leverage the architecture of a transformer model to capture long-range dependencies and complex structures in high-dimensional data. Specifically, the diffusion transformer models operate by processing token data of images and text (e.g., text of an inpainting request) to fully consider the long-range dependencies. Moreover, the diffusion transformer model as the diffusion inpainting model use the transformer architecture to predict the denoised data at each timestep (e.g., transformer block), and uses a self-attention mechanism to the noised data to understand how noise should be removed across various noised input tokens.

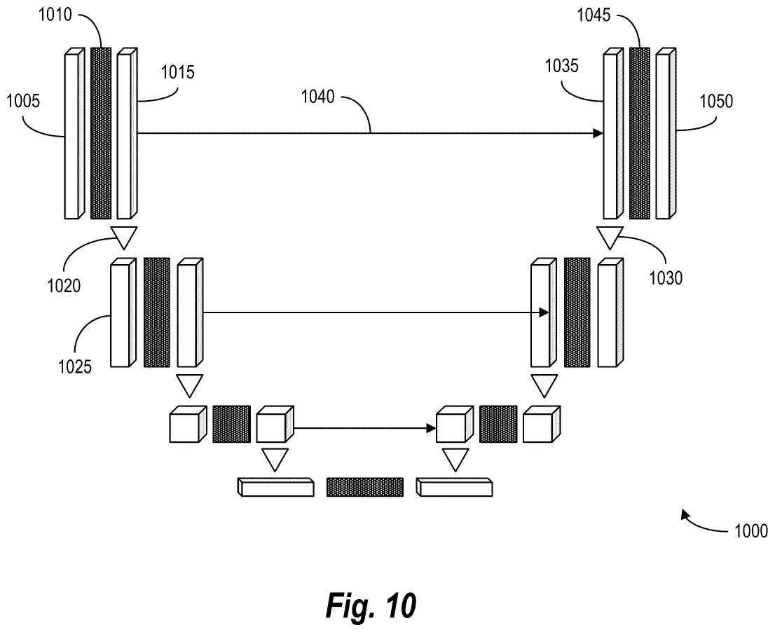

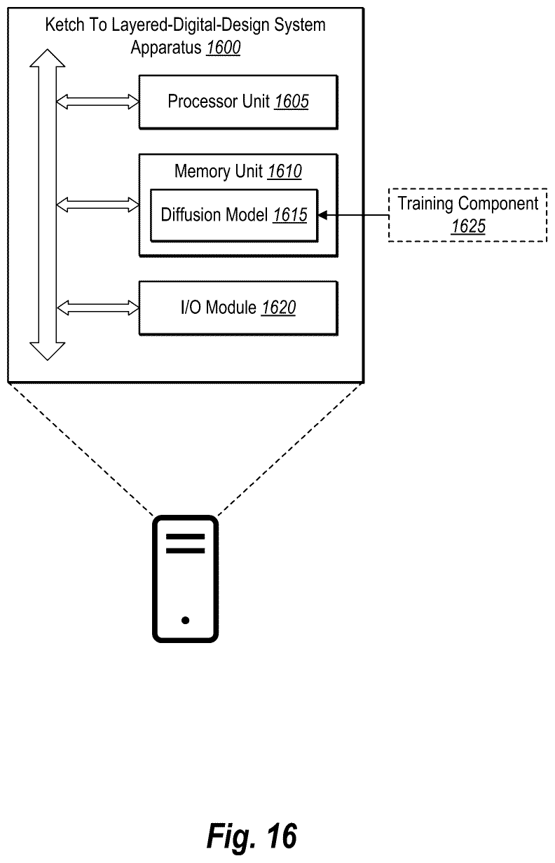

FIG. 10 shows an example of a U-Net 1000 according to aspects of the present disclosure. In some examples, U-Net 1000 is an example of the component that performs the reverse diffusion process 925 of the diffusion model 900 described with reference to FIG. 9 and includes architectural elements of the sketch to layered-digital-design system 106 described with reference to FIG. 16. The U-Net 1000 depicted in FIG. 10 is an example of, or includes aspects of, the architecture used within the reverse diffusion process described with reference to FIG. 9.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that the down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having the same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

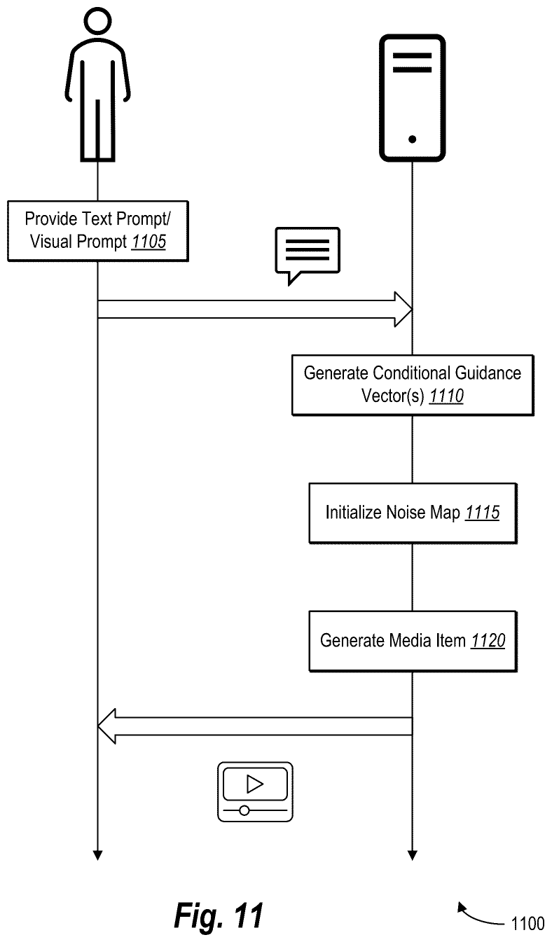

FIG. 11 shows an example of a method 1100 for media generation according to aspects of the present disclosure. In some examples, method 1100 describes an operation of the diffusion model such as an application of the diffusion model 900 described with reference to FIG. 9. In some examples, these operations are performed by a system including a processor executing a set of codes to control functional elements of an apparatus such as the sketch to layered-digital-design system 106 described above.

Additionally, or alternatively, steps of the method 1100 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1105, a user provides a text and/or visual prompt (e.g., an inpainting request) describing content to be included in a generated media item (e.g., guidance on how to inpaint pixels within a digital image). For example, a user may provide the prompt “remove the person playing with a cat”. In some examples, guidance can be provided in a form other than text, such as via an image (e.g., a visual prompt), a sketch, an audio input, or a layout.

At operation 1110, the system converts the text prompt (or other prompt guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model

At operation 1115, a noise map is initialized that includes random noise. The noise map may be in a pixel space or a latent space. By initializing a media item with random noise, different variations of a media item including the content described by the prompt can be generated. At operation 1120, the system generates a media item based on the noise map, and/or tokens from the prompt (e.g., text prompt and/or visual prompt).

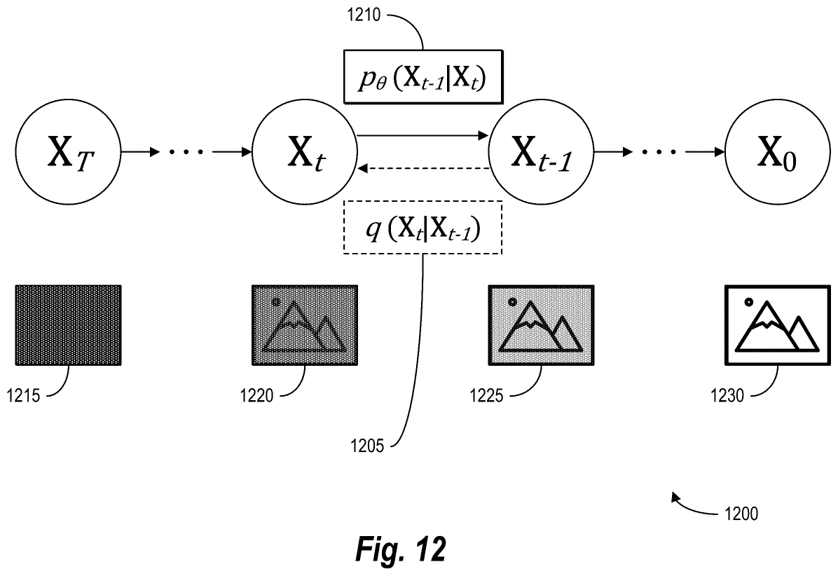

FIG. 12 shows a diffusion process 1200 according to aspects of the present disclosure. Specifically, FIG. 12 provides additional details of operating principles for a diffusion model. As described above with reference to FIG. 9, using a diffusion model can involve both a forward diffusion process 1210 for adding noise to a media item (or features in a latent space) and a reverse diffusion process 1205 for denoising the media item (or features) to obtain a denoised media item. The forward diffusion process 1210 can be represented as q(xₜ|xₜ₋₁), and the reverse diffusion process 1205 can be represented as p(xₜ₋₁|xₜ). In some cases, the forward diffusion process 1210 is used during training to generate media items with successively greater noise, and a neural network is trained to perform the reverse diffusion process 1205 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x₇ have the same dimensionality as x₀.

The neural network may be trained to perform the reverse process. During the reverse diffusion process 1205, the model begins with noisy data x_{T}, such as a noisy media item 1215 and denoises the data to obtain the p (xₜ₋₁| xₜ). At each step t−1, the reverse diffusion process 1205 takes xₜ, such as first intermediate media item 1220, and t as input. Here, t represents a step in the sequence of transitions associated with different noise levels, The reverse diffusion process 1205 outputs xₜ₋₁, such as second intermediate media item 1225 iteratively until x_{T} reverts back to x₀, the original media item 1230. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$$\begin{matrix}{x}_{T} : {p}_{θ} ( {x}_{0 : T} ) := p ( {x}_{T} ) {\prod }_{t = 1}^{T} & {p}_{θ} ( {x}_{t - 1} \vert {x}_{t} )\end{matrix} , \qquad ( 2 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

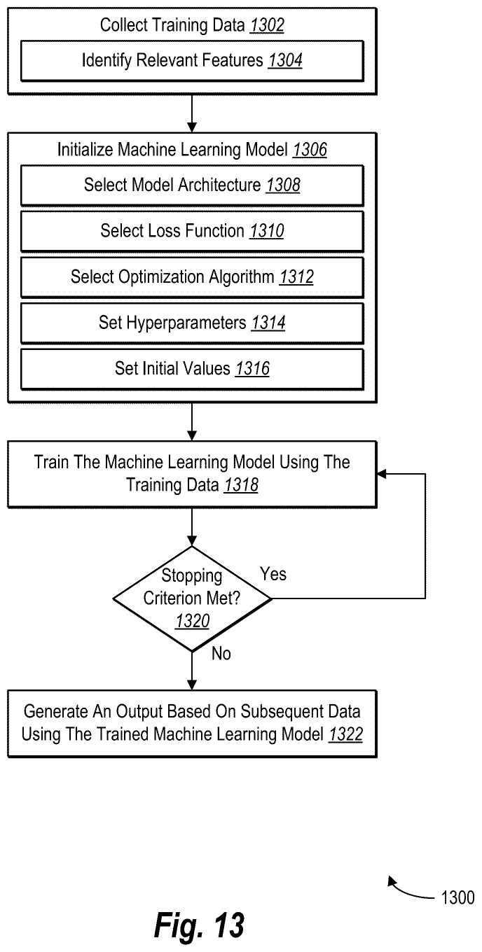

FIG. 13 is a flow diagram depicting an algorithm as a step-by-step procedure 1300 in an example implementation of operations performable for training a machine-learning model. In one or more embodiments, the procedure 1300 describes an operation of the training component described for configuring a diffusion model. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, diffusion transformer models, transformer models, diffusion models, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm 1312 is selected that is to be used in conjunction with the loss function to optimize parameters of the machine-learning model during training, examples of which include gradient descent, stochastic gradient descent (SGD), and so forth.

Initialization of the machine-learning model further includes setting initial values (block 1316) of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore once trained is configured to perform that task based on subsequent data received as an input and processed by the machine-learning model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

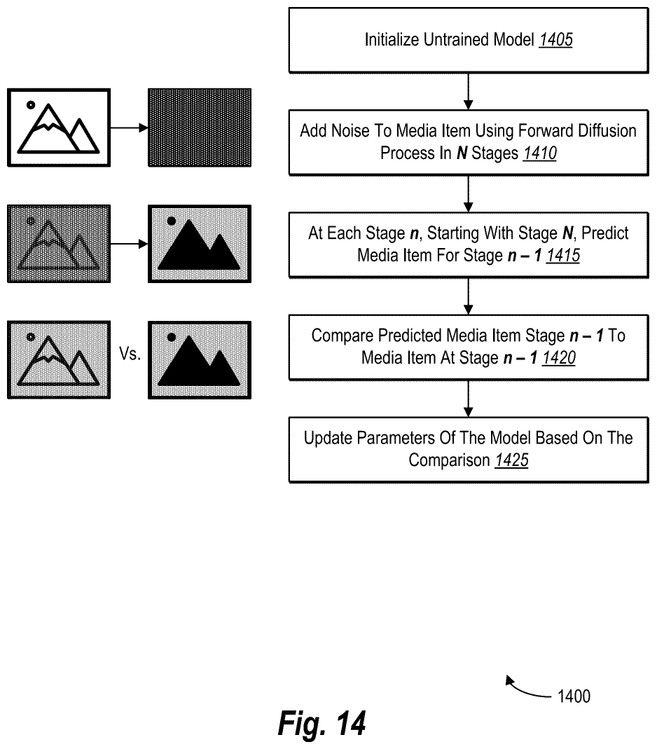

FIG. 14 shows an example of a method 1400 for training a diffusion model according to aspects of the present disclosure. In some embodiments, the method 1400 describes an operation of a training component described for configuring a diffusion model as described with reference to FIG. 16. The method 1400 represents an example for training a reverse diffusion process as described above with reference to FIG. 12. In some examples, these operations are performed by a system including a processor executing a set of codes to control functional elements of an apparatus, such as the guided diffusion model described in FIG. 9.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a media item using a forward diffusion process in N stages. In some cases, the forward diffusion process is a fixed process where Gaussian noise is successively added to media item. In latent diffusion models (e.g., the token space), the Gaussian noise may be successively added to features in a latent space.

At operation 1415, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1420, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1425, the system updates parameters of the model based on the comparison. For example, parameters of a U-Net may be updated using gradient descent. Time-dependent parameters of the Gaussian transitions can also be learned. However, in some embodiments, for the diffusion transformer model, the system updates parameters of each transformer block using a mean square error denoising loss.

FIG. 15 shows an example of a computing device 1500 according to aspects of the present disclosure. The computing device 1500 may be an example of the sketch to layered-digital-design system appartus (e.g., an apparatus for interacting with the sketch to layered-digital-design system 106, which is described above). In one aspect, computing device 1500 includes processor(s) 1505, memory subsystem 1510, communication interface 1515, I/O interface 1520, user interface component(s) 1525, and channel 1530.

In one or more embodiments, computing device 1500 is an example of, or includes aspects of, the sketch to layered-digital-design system 106 described above. In one or more embodiments, computing device 1500 includes one or more processors 1505 that can execute instructions stored in memory subsystem 1510 to perform media generation.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In one or more embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of a sketch to layered-digital-design system appartus 1600 according to aspects of the present disclosure. The sketch to layered-digital-design system appartus 1600 may include an example of, or aspects of, the diffusion model described with reference to FIG. 9. In one or more embodiments, sketch to layered-digital-design system appartus 1600 includes processor unit 1605, memory unit 1610, diffusion model 1615, I/O module 1620, and training component 1625. Training component 1625 updates parameters of the diffusion model 1615 stored in memory unit 1610. In some examples, the training component 1625 is located outside the sketch to layered-digital-design system appartus 1600.

Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors described with reference to FIG. 15.

Memory unit 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller may include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, sketch to layered-digital-design system appartus 1600 uses one or more processors of processor unit 1605 to execute instructions stored in memory unit 1610 to perform functions described herein. For example, the sketch to layered-digital-design system appartus 1600 to perform the operations described in the aspects below.

The memory unit 1610 may include a diffusion model 1615 trained to remove noise from noised data. For example, after training, the diffusion model 1615 may perform inferencing operations as described with reference to FIGS. 9-10 to remove noise from noised data and generate media such as a modified digital image (e.g., that contains inpainted pixels).

In one or more embodiments, the diffusion model 1615 is an Artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. Specifically, each denoising block of the diffusion model 1615 can represent the connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model. Accordingly, the multi-layer perceptrons within each denoising block of the diffusion model represents various aspects of an ANN.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the diffusion model 1615 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1625 may train the diffusion model 1615. For example, parameters of the diffusion model 1615 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion model 1615 can be used to make predictions on new, unseen data (i.e., during inference).

I/O module 1620 receives inputs from and transmits outputs of the sketch to layered-digital-design system appartus 1600 to other devices or users. For example, I/O module 1620 receives inputs for the diffusion model 1615 and transmits outputs of the diffusion model 1615. According to some aspects, I/O module 1620 is an example of the I/O interface described with reference to FIG. 15.

What is claimed is:

1. A computer-implemented method comprising:
determining at least one of a canvas size or an aspect ratio of a sketch image;
generating, based on the at least one of the canvas size or the aspect ratio, a compositional reference of the sketch image utilizing a binarization model by:
normalizing lighting of the sketch image;
enhancing contrast of the sketch image; and
converting the sketch image to a binary format;
generating, utilizing one or more machine learning models, a digitized digital design of the sketch image based on the compositional reference; and
generating a layered digital design document comprising a background layer based on the digitized digital design and editable text elements based on the compositional reference.

2. The computer-implemented method of claim 1, wherein generating the compositional reference of the sketch image utilizing the binarization model further comprises utilizing a smoothing model to smooth noise of the sketch image.

3. The computer-implemented method of claim 1, wherein generating the compositional reference of the sketch image utilizing the binarization model comprises utilizing a histogram equalization model to normalize the lighting and enhance the contrast of the sketch image.

4. The computer-implemented method of claim 1, wherein generating the compositional reference of the sketch image utilizing the binarization model comprises utilizing adaptive thresholding to convert the sketch image to the binary format.

5. The computer-implemented method of claim 1, wherein generating the compositional reference of the sketch image utilizing the binarization model further comprises utilizing morphological closing to remove at least one of a hole or a gap in the binary format of the compositional reference.

6. The computer-implemented method of claim 1, wherein generating, utilizing the one or more machine learning models, the digitized digital design of the sketch image based on the compositional reference comprises:
generating, utilizing a text encoder, text embeddings based on the compositional reference of the sketch image;
generating, utilizing an image encoder, image embeddings from the compositional reference of the sketch image; and
generating, utilizing a diffusion model, the digitized digital design of the sketch image by conditioning the diffusion model on the text embeddings and the image embeddings.

7. The computer-implemented method of claim 6, wherein generating the text embeddings based on the compositional reference of the sketch image comprises:
generating, utilizing a vision-language model and the compositional reference, one or more text-to-image prompts; and
generating, utilizing the text encoder, the text embeddings from the one or more text-to-image prompts.

8. A system comprising:
one or more memory devices; and
one or more processors configured to cause the system to:
generate, utilizing one or more machine learning models, text embeddings from a compositional reference of a sketch image;
generate, utilizing an image encoder, image embeddings from the compositional reference of the sketch image; and
generate, utilizing a diffusion model, a digitized digital design of the sketch image by conditioning the diffusion model on the text embeddings and the image embeddings.

9. The system of claim 8, wherein generating the text embeddings from the compositional reference of the sketch image comprises:
generating, utilizing a vision-language model and the compositional reference, one or more text-to-image prompts; and
generating, utilizing a text encoder, the text embeddings from the one or more text-to-image prompts.

10. The system of claim 8, wherein the one or more processors are further configured to:
generate, utilizing a binarization model, a clean sketch image of the sketch image;
extract, utilizing an optical character recognition model, a text string from the clean sketch image;
determine, utilizing a font detection model, a font of the text string based on text of the clean sketch image; and
generate, based on the text string and the font of the text string, an editable text element.

11. The system of claim 10, wherein determining the font of the text string based on the text of the clean sketch image comprises generating filled contours of characters of the text string utilizing a morphological opening operation.

12. The system of claim 10, wherein the one or more processors are further configured to determine a font size of the text string based on the text of the clean sketch image.

13. The system of claim 8, wherein the one or more processors are further configured to generate a digital design document based on the digitized digital design of the sketch image.

14. The system of claim 13, wherein generating the digital design document based on the digitized digital design of the sketch image comprises:
generating a background layer based on the digitized digital design; and
overlaying one or more editable text elements on the background layer.

15. A non-transitory computer readable medium storing executable instructions which, when executed by a processing device, cause the processing device to perform operations comprising:
generating, utilizing a diffusion model, a digitized digital design from a sketch image;
extracting, utilizing a segmentation model, text regions from the digitized digital design;
generating, utilizing an inpainting model, a complete background layer by inpainting regions corresponding to the extracted text regions of the digitized digital design; and
generating a digital design document comprising the complete background layer and one or more editable text elements.

16. The non-transitory computer readable medium of claim 15, wherein generating the digital design document comprises applying layered vectorization to the complete background layer by:
segmenting a visual element of the complete background layer; and
filling a background of the segmented visual element to generate a complete visual element.

17. The non-transitory computer readable medium of claim 15, wherein generating the digital design document comprises overlaying the one or more editable text elements based on one or more visual elements of the complete background layer.

18. The non-transitory computer readable medium of claim 15, wherein the operations further comprise:
generating a clean sketch image of the sketch image based on at least one of a canvas size or an aspect ratio of the sketch image;
determining, utilizing an optical character recognition model, one or more text bounding boxes from the clean sketch image of the sketch image; and
wherein extracting, utilizing the segmentation model, the text regions from the digitized digital design comprises utilizing the segmentation model to extract the text regions based on the one or more text bounding boxes.

19. The non-transitory computer readable medium of claim 15, wherein the operations further comprise:
generating a compositional reference of the sketch image utilizing a binarization model; and
wherein generating, utilizing the diffusion model, the digitized digital design from the sketch image comprises conditioning the diffusion model on at least one of a set of text embeddings or a set of image embeddings based on the compositional reference.

20. The non-transitory computer readable medium of claim 19, wherein generating the compositional reference of the sketch image utilizing the binarization model comprises:
utilizing a histogram equalization model to normalize a lighting and enhance a contrast of the sketch image; and
utilizing adaptive thresholding to convert the sketch image to a binary format.
